(19) United States
(12) Patent Application Publication
(10) Pub. No.: US 2009/0186577 A1
(43) Pub. Date: Jul. 23, 2009

(54) APPARATUS AND METHOD FOR DETERMINING NETWORK ASSOCIATION STATUS

(76) Inventors: John Anderson Fergus Ross, Niskayuna, NY (US); David Michael Davenport, Niskayuna, NY (US); Michael James Hartman, Clifton Park, NY (US); John Erik Hershey, Ballston Lake, NY (US); David George Hernke, Sussex, WI (US); Neal John Seidl, Pewaukee, WI (US); Matthew George Grubis, New Berlin, WI (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 12/016,779

(22) Filed: Jan. 18, 2008

(51) Int. Cl. H04B 7/00

(52) U.S. Cl. 455/41.2

(57) ABSTRACT

An apparatus and method for determining network association status includes a first electronic device having a wireless communication system and a proximity system, and a second electronic device having a wireless communication system and a proximity system. The wireless communication systems of the first and second electronic devices have a communication range therebetween greater than an interaction range between the proximity systems of the first and second electronic devices. The proximity system of one of the first and second electronic devices is configured to interact with the proximity system of the other of the first and second electronic devices to determine proximity between the first and second electronic devices. The communication system of the first electronic device is configured to establish an association status communication with the communication system of the second electronic device after the proximity of the first and second electronic devices has been determined. Further, one of the first and second electronic devices is configured to notify an operator of an association status of the first and second electronic devices.

### BACKGROUND OF THE INVENTION

Embodiments of the invention relate generally to wireless networks for patient monitoring and, more particularly, to association between devices of a wireless network for communication therebetween.

Monitoring vital signs is an important part of patient care as the general or particular health of the patient is determined, in part, through measurement and interpretation of key physiological indicators. Well-known parameters of patient health include blood pressure, hemoglobin saturation, and features of the electrocardiogram (ECG).

However, the utilization of physiological instrumentation to obtain those measurements at bedside also possesses well-known burdens to the clinical environment. The presence of cables, catheters, and tubing connecting the patient and sensors to the instrumentation can diminish productivity and the quality of patient care. For example, rotating a patient to alleviate bedsores or ambulating about the room can be problematic if one is saddled with tethered devices. Procedural delays stemming from cable management also contribute to a greater percentage of time dedicated to routine, mundane tasks not directly related to treatment of the patient's illness.

The longstanding problem has remained unsolved for a variety of reasons. A major problem involves the varying levels of care one might experience in receiving care in the hospital. A single patient, for instance, may easily progress from low-acuity monitoring at admissions to high acuity monitoring within a specialized care unit, to a lower acuity level involving ordinary cardiac telemetry, and finally to discharge. To meet this need of evolving care, a variety of instrumentation has been developed to accommodate the monitoring needs. These monitoring instruments can be added or subtracted from the patient's monitoring regime, depending on the patient's needs. However, these adaptive needs only add to the burden of cable and device management.

Wireless communication technology leveraged to patient monitoring may at least circumvent some of the problems associated with cable clutter and device management. With instrumentation becoming wireless, the management of such devices is eased. In addition, wireless instrumentation/devices greatly reduces the burdens associated with cable management.

Wireless patient monitoring networks, however, bring new problems that need to be addressed for proper implementation of a monitoring regime. In many instances, whether using a wireless monitoring system or a wired system, elements of the system communicate with at least one central management device. In the hospital environment, this management device is often used to relay monitor information to an infrastructure that allows health care professionals to analyze the monitor information from an outside location (i.e. a nurse station). In other wireless systems, the management device may be integrated with a central processing unit that analyzes incoming device information. When cables are removed from these devices, a user of the system can no longer safeguard that the devices are properly connected to the management device by simply ensuring that the cables are connected. That is, without cables, a health care provider or other operator, lacks the visual cues associated with cables to assure that the sensing devices are properly connected to the management device. This problem becomes more serious when one realizes that there is a possibility that a patient's wireless sensing device could be inadvertently broadcasting sensing information to a management device of another patient.

Therefore, it would be desirable to design an apparatus and method to ensure that a body-worn wireless patient sensing device is properly connected to the appropriate management device.

### BRIEF DESCRIPTION OF THE INVENTION

Embodiments of the invention are directed to an apparatus and method for associating devices of a wireless network that overcome the aforementioned drawbacks. A pair of devices include communication and proximity sensing systems. The communication systems initiate an association status communication once the proximity sensing systems have indicated that the pair of devices are proximate.

In accordance with one aspect, a wireless system includes a first electronic device having a wireless communication system and a proximity system and a second electronic device having a wireless communication system and a proximity system. The wireless communication systems of the first and second electronic devices have a communication range therebetween greater than an interaction range between the proximity systems of the first and second electronic devices. The proximity system of one of the first and second electronic devices is configured to interact with the proximity system of the other of the first and second electronic devices to determine proximity between the first and second electronic devices. The communication system of the first electronic device is configured to establish an association status communication with the communication system of the second electronic device after the proximity of the first and second electronic devices has been determined. Further, one of the first and second electronic devices is configured to notify an operator of an association status of the first and second electronic devices.

In accordance with another aspect, a method for managing wireless devices in a wireless network includes determining a presence of one of a pair of electronic devices within a proximity zone of the other of the pair of electronic devices, determining an association status of the pair of electronic devices to each other after the presence of the one of the pair of electronic devices is determined to be within the proximity zone of the other electronic device, and notifying an operator of the association status of the pair of electronic devices. The pair of electronic devices each have a wireless communication system, where the wireless communication systems are configured to communicate in a communication zone having a larger area than an area of the proximity zone.

In accordance with yet another aspect, a wireless system includes a proximity sensing system configured to wirelessly sense a proximity of a central hub device to a peripheral device within a proximity range of the proximity sensing system, a wireless communication system having a communication range greater than the proximity range, and a notification system configured to notify an operator of an association status of the central hub device and the peripheral device. The wireless communication system is configured to perform wireless communications between the central hub device and the peripheral device, and activate an association status communication between the central hub device and the peripheral device. The association status communication is activated after the proximity of the central hub device to the peripheral device has been sensed.

Various other features and advantages of the invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is a schematic block diagram of two components of a wireless system in proximity according to an embodiment of the invention.

FIG. 2 is a schematic block diagram of the wireless system of FIG. 1 showing the two components not in proximity according to an embodiment of the invention.

FIG. 3 is a flowchart depicting a technique for determining an association status of the components of FIGS. 1 and 2 according to an embodiment of the invention.

FIG. 4 is a flowchart depicting a timer interrupt routine according to an embodiment of the invention.

FIG. 5 is a flowchart diagram depicting a communication failure disassociation routine according to an embodiment of the invention.

FIG. 6 is a schematic block diagram depicting the notification of association status of peripheral devices in a wireless network according to an embodiment of the invention.

### DETAILED DESCRIPTION OF THE PREFERRED EMBODIMENT

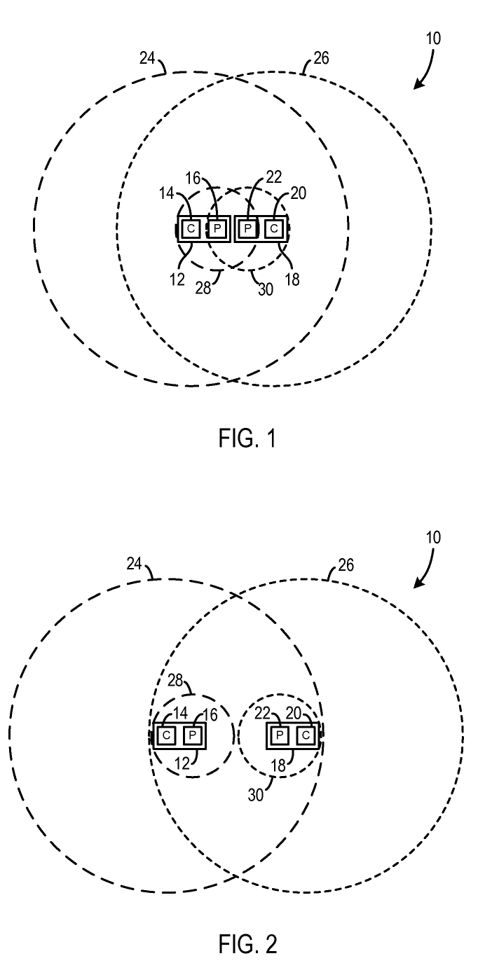

Referring to FIGS. 1 and 2, a schematic block diagram of a wireless system 10 according to an embodiment of the invention is shown. Wireless system 10 includes a first electronic device 12 having a communication system 14 and a proximity sensing system 16. Wireless system 10 also includes a second electronic device 18 having a communication system 20 and a proximity sensing system 22. In one embodiment, communication systems 14, 20 are wireless communication systems configured to wirelessly communicate with each other through radio frequency communications, infrared communications, or other known wireless communication systems. Communication systems 14, 20 have a communication area or range 24, 26, respectively, that allows communications with other communication systems positioned within communication ranges 24, 26. Accordingly, communication systems 14, 20 may communicate with each other when positioned in communication ranges 26, 24, respectively. According to an embodiment of the invention, communication systems 14, 20 employ radio frequency signals. It is also contemplated, however, that communication systems 14, 20 may include infra red, ultrasound, magnetic field signals, and-or other forms of wireless communication.

Proximity sensing systems 16, 22 have an interaction range or proximate zone 28, 30, respectively, that allows interaction with another proximity sensing system positioned therein. Accordingly, proximity sensing systems 16, 22 may interact with each other when positioned in proximity zones 30, 28, respectively. According to an embodiment of the invention, proximity sensing systems 16, 22 are combinations of a mechanical switch such as a magnetic reed switch and small, permanent magnet(s), where one proximity system, such as proximity system 16, for example, has a magnet to engage a reed switch in the other proximity system, such as proximity system 22, for example. However, it is contemplated that proximity sensing systems 16, 22 may include near-field or Hall-effect magnetic sensing detectors, radio-frequency ID (“RFID”) detectors, or devices responsive to field strength such as a field strength detector or a field strength temporal gradient detector that detect field strength resulting from a source of radio frequency, ultrasound, visible light, infra red, or the like. It is also contemplated that proximity sensing systems 16, 22 may include non-wireless proximity sensing devices, such as electrical contacts or switches that detect proximity when electrically coupled to each other.

According to an embodiment of the invention, the area or radius of communication ranges 24, 26 is greater than the area or radius of proximate zones 28, 30. However, one skilled in the art will recognize that communication ranges 24, 26 and proximate zones 28, 30 as shown in FIG. 1 are schematic representations and that the areas or radii of communication ranges 24, 26 and proximate zones 28, 30 may be greater than or less than that depicted while still maintaining a larger communication range than proximate zone. Furthermore, while the communication ranges 24, 26 and proximate zones 28, 30 are shown to have an omni-directional sensitivity centered on communications systems 14, 20 and proximity sensing systems 16, 22, respectively, it is contemplated that communication ranges 24, 26 and proximate zones 28, 30 may be focused in one direction more than another. The directionality and focus of communication ranges 24, 26 and proximate zones 28, 30 depend at least in part on the type and quality of communication and proximity sensing systems used.

As shown in FIG. 1, proximity sensing system 16 is within proximate zone 30 of proximity sensing system 22, and proximity sensing system 22 is within proximate zone 28 of proximity sensing system 16. Accordingly, proximity sensing systems 16, 22 interact to sense their mutual proximity. As shown in FIG. 2, proximity sensing systems 16, 22 are not within the proximate zones 30, 28, respectively, so no interaction between proximity sensing systems 16, 22 occurs. However, while no proximity interaction occurs between proximity sensing systems 16, 22 as shown in FIG. 2, communication between communication systems 14, 20 may occur since communication system 14 is within communication range 26 and communication system 20 is within communication range 24. Any wireless communication between systems 14 and 20 requires prior proximity of devices 12 and 18 as determined by their respective proximity sensing systems, 16 and 22.

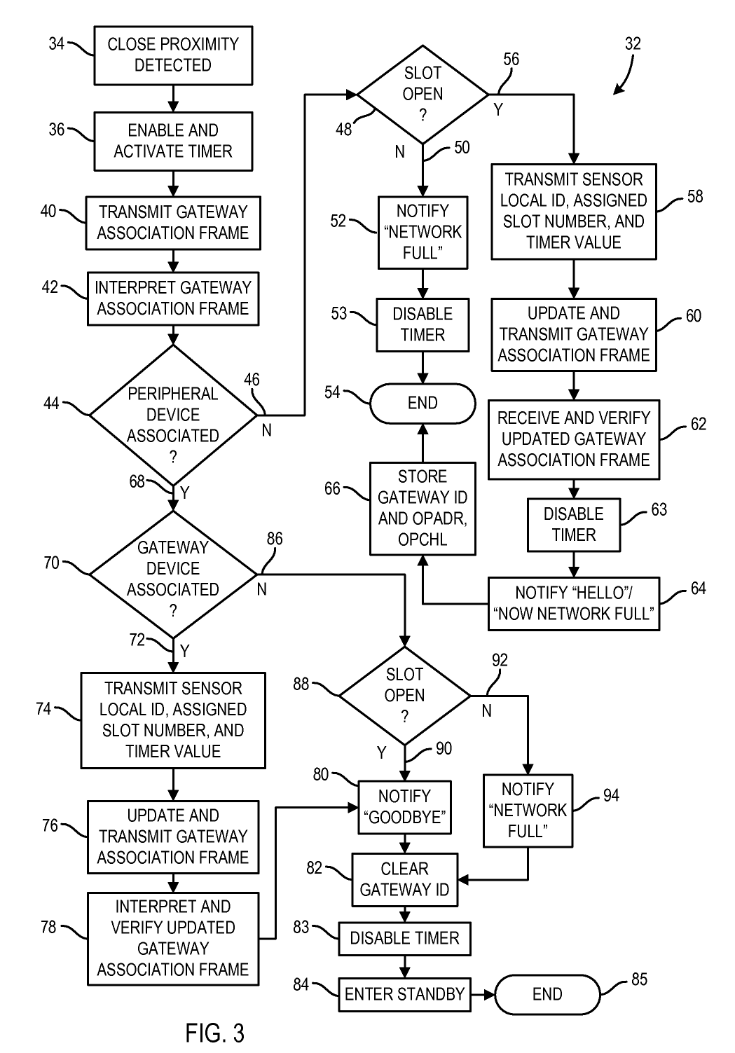

FIG. 3 shows a technique 32 for determining an association status between first and second electronic devices 12, 18 according to an embodiment of the invention. In an embodiment of the invention, first and second electronic devices 12, 18 includes one or more processors (not shown) for carrying out steps of technique 32. It is contemplated that first electronic device 12 may be a central hub device to which a peripheral device, such as second electronic device 18, becomes associated therewith for communications therebetween or becomes disassociated therewith for terminating established communications therebetween. In an embodiment of the invention, the central hub device 12 is a gateway configured to communicate with peripheral devices 18, such as patient monitoring sensors or body-worn devices, associated therewith. Accordingly, the gateway 12 is configured to wirelessly collect patient health parameters acquired by patient monitoring sensors 18 for treatment and-or monitoring of health care patients.

Referring to FIG. 3, technique 32 begins at STEP 34 with the detection or sensing of close proximity between gateway 12 and peripheral device 18. The close proximity is determined from the state of proximity indicating that mutual interaction exists between proximity sensing systems 16, 22 of devices 12, 18 as shown in FIG. 1. According to an embodiment of the invention, after detection of close proximity at STEP 34, a timer is enabled and set or activated in each device 12, 18 at STEP 36. The timers in each device 12, 18 are substantially synchronized to the detection of proximity and set for a predetermined time period, which delineates a time frame in which the technique 32 for determining an association status should be performed. In addition, and which will be described below more fully, the timer helps to identify the device 12, 18 for which association status is sought and from which communication is received. The activation of timers in STEP 36 also allows for processing of the remaining steps of technique 32 even after the gateway 12 and the peripheral device 18 are no longer proximate as long as the communication systems 14, 20 are within communication zones 26, 24, respectively.

After timer activation 36, a gateway association frame or network key is transmitted from gateway 12 to peripheral device 18 at STEP 40. Transmission of the gateway association frame at STEP 40 begins an association status communication between devices 12, 18. In one embodiment, the gateway association frame is transmitted using a default radio channel and a default address where the default values are known to all devices that may be associated or disassociated. The use of default parameters permits successful association or disassociation without the exchange of wireless discovery messages prior to the proximity of devices 12 and 18. The gateway association frame includes communication slot information regarding the wireless network and information regarding the timer of the gateway 12. For example, the gateway timer information may include the current state or count of the gateway timer. At STEP 42, the peripheral device 18 interprets the gateway association frame and compares the gateway timer information to the timer of the peripheral device 18. If the timer of the peripheral device 18 corresponds to the timer of the gateway 12 within a predetermined period or range, then peripheral device 18 knows that the received gateway association frame is from the correct gateway 12. Peripheral device 18 further interprets data in the gateway association frame at STEP 42 and determines a current association status or network status of peripheral device 18 to gateway 12 at STEP 44.

The current association status is a status of association between the gateway 12 and peripheral device 18 based on data stored in internal memory of peripheral device 18. The data, if null, equal to a predetermined value, or within a range of predetermined values, indicate that peripheral device 18 is not associated to gateway 12; otherwise, the data indicate that peripheral device 18 is associated to gateway 12.

If the current association status indicates at 46 that peripheral device 18 is not associated to gateway 12, then peripheral device 18 checks the association frame to determine if a communication slot is open and available for associating peripheral device 18 to gateway 12 at STEP 48. According to an embodiment of the invention, a communication slot refers to, as known in the art, a defined temporal interval within a Time Division Multiple Access network. In addition, as known in the art, a communication slot may also refer to the maximum number of nodes permitted in a network employing Carrier Sense Multiple Access or other network access schemes to ensure a desired quality of service among members of the wireless network. Additionally, in an embodiment of the invention, the association frame includes association flags that correspond to respective communication slots and identify whether the respective communication slot is available or unavailable. For example, in a network having sixteen communication slots, sixteen association flags may correspond to two bytes of information (AT0 and AT1) within the association frame. A value of 0xC0 for AT0 and 0x00 for AT1 may indicate that the first two slots are unavailable while the remaining fourteen are free. In addition, the association frame includes an ID portion (i.e., SN0, SN1, SN2, . . . ) for each association flag to indicate a gateway assigned ID number. In one embodiment of the invention, the ID portions corresponding with unavailable communication slots and corresponding with the first available communication slot comprise non-zero values. If there is no open communication slot 50 for associating peripheral device 18 to gateway 12, for example, where AT0 and AT1 may both have values of 0xFF, peripheral device 18 provides an indication that the network is full at STEP 52 such that an operator or technician attempting to associate peripheral device 18 to gateway 12 is notified of the full network, which also indicates that peripheral device 18 has not been associated with gateway 12. According to an embodiment of the invention, for notification purposes, a peripheral device 18 may include a noise making device, an LED or other visual device, or a tactile device such as a vibration unit for notifying the operator through sound, light, or tactile methods. In another embodiment, the notification could be implicit, since successful association will result in communication outside the proximity range, but within the communication range after association has been established. Other devices and methods for notifying the operator are also considered to be within the scope of an embodiment of the invention. Following the notification of a full network at 52, the peripheral device timer is cleared or disabled 53 and technique 32 ends at 54.

Referring again to STEP 48, if a communication slot is open 56 and available for associating peripheral device 18 to gateway 12, peripheral device 18 transmits an association information packet reply including its sensor local identification (ID) number, its timer information, and the number of the available communication slot to gateway 12 at STEP 58. Gateway 12 updates the association frame and transmits the updated association frame to peripheral device 18 at STEP 60 if the timer of the peripheral device 18 corresponds to the timer of the gateway 12 within a predetermined period or range. In one embodiment of the invention, gateway 12 updates the association frame by writing the sensor local ID number to a sensor acknowledgment (SNACK) portion of the association frame, updating AT0 or AT1 to indicate that the available communication slot identified by peripheral device 18 has become unavailable, determining a non-zero gateway assigned ID for the slot identified by peripheral device 18, writing the operating address (OPADR) for messages exchanged during operating mode, writing the operating channel (OPCHL) for use during the operating mode, and updating the timer information of the gateway 12. The operating channel may relate to a specific carrier frequency, a pattern of frequencies, a code for Code Division Multiple Access, or other mechanism for sharing the wireless medium. In one embodiment, the operating channel and operating address are unique to a specific gateway device 12, and provided to all peripheral devices 18 in the gateway association frame.

The peripheral device receives and interprets the updated association frame at STEP 62. If the timer of the gateway 12 corresponds to timer of the peripheral device 18 within a predetermined range, peripheral device 18 verifies data in the updated association frame at STEP 62. In one embodiment, peripheral device 18 verifies that its sensor local ID has been stored in the SNACK. The timer of peripheral device 18 is cleared or disabled at STEP 63, and the peripheral device 18 notifies the operator at STEP 64 that association with gateway 12 has been successful. In addition, it is contemplated that peripheral device 18 may notify the operator if the peripheral device 18 associated itself to and joined the network in the last remaining open communication slot. Accordingly, in addition to notifying the operator that the association was successful, the operator may be notified that the network is now full, indicating that no more peripheral devices may be added to the current network setup. Peripheral device 18 further stores its gateway assigned ID, the operating address (OPADR) of the gateway 12, and the operating channel (OPCHL) in its internal memory at STEP 66. Process control then proceeds to end 54. One skilled in the art will recognize that STEPS 63-66 may be re-ordered according to an embodiment of the invention. At this point, devices 12, 18 are associated and transition to an operating mode (not shown) where further exchange of data and information may occur.

Referring again to STEP 44, if the current association status indicates at 68 that peripheral device 18 is associated to gateway 12, then peripheral device 18 checks the association frame at STEP 70 to determine if gateway 12 is associated to peripheral device 18. In an embodiment of the invention, peripheral device 18 acquires its gateway assigned ID number stored in its internal memory and compares its assigned ID number to the assigned ID numbers within an ID portion of the association frame. If the assigned ID number stored in peripheral device 18 matches 72 an assigned ID number in the association frame, for example, in SN2, then peripheral device 18 transmits its sensor local ID number, its timer information, and the number of the communication slot to which it was assigned by gateway 12 at STEP 74. Gateway 12 receives, updates, and transmits the updated association frame to peripheral device 18 at STEP 76 if the timer of the peripheral device 18 corresponds to the timer of the gateway 12 within a predetermined period or range. In one embodiment, gateway 12 verifies that the communication slot number was associated with peripheral device 18 and writes the sensor local ID number into the SNACK. Gateway 12 further updates the association frame by determining the next free slot and assigned ID number for the ID portion associated therewith updating the association flags AT0 and AT1 as needed, and updating the timer information of the gateway 12.

At STEP 78, peripheral device 18 interprets and verifies the updated gateway association frame if the timer of the peripheral device 18 corresponds to the timer of the gateway 12 within a predetermined period or range. For example, peripheral device 18 verifies that its sensor local ID has been stored in the SNACK. Following the verification, peripheral device 18 notifies the operator that peripheral device 18 has been disassociated from gateway 12 at STEP 80. Peripheral device 18 further clears any gateway assigned ID stored in its internal memory at STEP 82. The timer of peripheral device 18 is cleared or disabled at STEP 83, and peripheral device 18 enters a stand-by mode at STEP 84, during which it will neither transmit nor receive messages via wireless communication system 20 until it detects proximity again. Process control then ends at STEP 85.

Referring again to STEP 70, if the assigned ID number stored in peripheral device 18 does not match 86 an assigned ID number in the association frame, peripheral device 18 decodes the association flags to determine if there is a communication slot open at STEP 88. If a communication slot is available 90, process control proceeds to STEP 80 as described above for notifying the operator that peripheral device 18 has been disassociated from gateway 12 and for clearing any gateway assigned ID stored in internal memory. If a communication slot is not available 92, peripheral device 18 notifies the operator that the network is full at STEP 94, clears any gateway assigned ID stored in internal memory at STEP 82, and disables the timer of peripheral device 18 at STEP 83. Process control then ends at STEP 84. One skilled in the art will recognize that the order of STEPS 80, 82, and 83 and the order of STEPS 94, 82, and 83 may be re-ordered according to an embodiment of the invention.

Accordingly, as described above with respect to FIG. 3, if the current association status indicates that peripheral device 18 is not associated with gateway 12, then peripheral device 18 attempts to associate itself with gateway 12. If the network is open, i.e., an open communication slot exists for communicating with gateway 12, then peripheral device 18 associates itself, which includes assigning itself to the open communication slot, with gateway 12 and becomes part of the wireless communication network of all devices 18 communicating with gateway 12. If the network is full, i.e., no open communication slot exists for communicating with gateway 12, then peripheral device 18 remains disassociated from gateway 12 and does not form part of the network of all devices 18 communicating with gateway 12.

If, on the other hand, the current association status indicates that peripheral device 18 is associated with gateway 12, then peripheral device 18 removes itself from the network of all devices 18 communicating with gateway 12 and disassociates itself from gateway 12. If peripheral device 18 determines from the association frame that gateway 12 associated peripheral device 18 thereto and within the wireless network, then peripheral device 18 and gateway 12 communicate to cooperatively disassociate peripheral device 18 from gateway 12. If peripheral device 18 determines from the association frame that gateway 12 has no association of peripheral device 18 thereto and within the wireless network, then peripheral device 18 disassociates itself from gateway 12 without communication therewith.

While the embodiment described above in FIG. 3 uses timers to allow technique 32 to be completed if devices 12, 18 are moved outside of proximate zones 30, 28, respectively, technique 32 may be performed without setting or starting timers in devices 12, 18 according to another embodiment of the invention. Thus, it is contemplated that if timers are not enabled, completion of technique 32 for at least the mutual association or disassociation of devices 12, 18 can only be completed while the devices 12, 18 remain in the proximate zones 30, 28, respectively. That is, if devices 12, 18 are proximate, then technique 32 is allowed to be completed. If devices 12, 18 cease to be proximate before completion of technique 32, then technique 32 is not allowed to be completed. Also, if timers are not used in technique 32, timer activation, transmission, comparison, and de-activation is not performed.

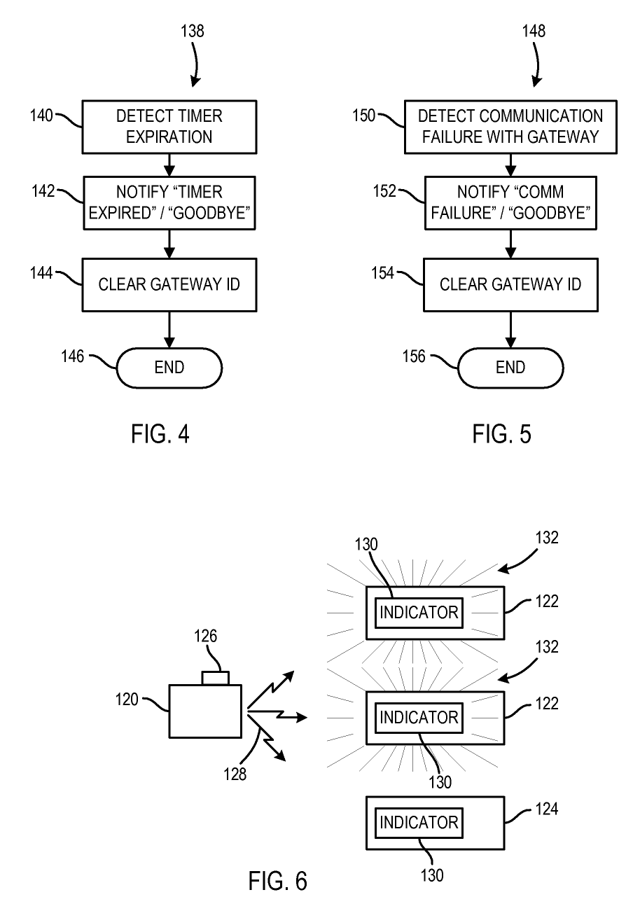

Referring now to FIG. 4, a flowchart shows a timer interrupt routine 138 according to an embodiment of the invention. When a timer is used in technique 32 of FIG. 3, expiration of the sensor timer before it is cleared at STEPS 53, 63, and 83 of FIG. 3 will cause the timer interrupt routine 138 to execute in peripheral device 18. At STEP 140, expiration of the timer of peripheral device 18 begins disassociation steps in peripheral device 18. At STEP 142, the operator is notified that the timer has expired and may also be notified that peripheral device 18 is or will be disassociated from gateway 12. The peripheral device 18 then clears any gateway ID stored in its internal memory at STEP 144, thus disassociating peripheral device 18 from gateway 12. Process control then ends at STEP 146. One skilled in the art will recognize that STEPS 142-144 may be re-ordered according to an embodiment of the invention.

FIG. 5 shows a flowchart of a communication failure routine 148 according to an embodiment of the invention. Communication failure routine 148 may be executed if an associated peripheral device 18 detects a communication failure with its associated gateway 12. Peripheral device 18 may execute communication failure routine 148 after a predetermined non-communication time or after a predetermined number of communication failures. At STEP 150, peripheral device 18 detects a communication failure with gateway 12. At STEP 152, peripheral device 18 notifies an operator that it is or will be disassociated from gateway 12. The operator may also be notified that a communication failure has occurred. The peripheral device 18 then clears any gateway ID stored in its internal memory at STEP 154, thus disassociating peripheral device 18 from gateway 12. Process control then ends at STEP 156. One skilled in the art will recognize that STEPS 152-154 may be re-ordered according to an embodiment of the invention.

FIG. 6 shows a schematic block diagram of a central hub device 120 and peripheral devices 122, 124 for verifying and indicating the association of each device 120-124 in the wireless network according to an embodiment of the invention. A switch or button 126 on the central hub device 120 is activated by an operator to cause a wireless signal 128 to be sent to and received by peripheral devices 122, 124 to signal their association to central hub device 120 to an operator. In one embodiment, the wireless signal 128 is broadcast to all peripheral devices 122, 124 at once. In another embodiment, each peripheral device 122 receives the wireless signal 128 during its communication time slot with central hub device 120. Each peripheral device 122, 124 includes indicator 130 for indicating to the operator its association status with central hub device. Indicator 130 may be a noise making device, a light emitting diode (LED), a liquid crystal display (LCD) or other visual device, or a tactile device such as a vibration unit. Associated peripheral devices 122 receive wireless signal 128 and activate indicator 130 to signal 132 that they are associated with central hub device 120. An unassociated peripheral device 124, however, will not indicate an association status with central hub device 120 when the button 126 on the central hub device 120 is activated.

Still referring to FIG. 6, in an alternate embodiment, the indicators 130 may become active for associated peripheral devices 122 after activation and remain in an active or semi-active state for the duration of the association. For example, indicators 130 may be LEDs that indicate association by blinking on and off in a semi-active state to reduce battery consumption.

An advantage of the invention is that power consumption is reduced by avoiding extraneous message transmissions and by minimizing time spent listening for a wirelessly communicated message. Since the invention engages in the exchange of an association message(s) over the communication link only after the proximity sensing system has detected a proximate device, the need for other wireless discovery techniques that can interfere with the operation of an active wireless system is reduced or eliminated.

A technical contribution for the disclosed apparatus and method is that is provides for a processor implemented association between devices of a wireless network for communication therebetween.

In accordance with one embodiment, a wireless system includes a first electronic device having a wireless communication system and a proximity system and a second electronic device having a wireless communication system and a proximity system. The wireless communication systems of the first and second electronic devices have a communication range therebetween greater than an interaction range between the proximity systems of the first and second electronic devices. The proximity system of one of the first and second electronic devices is configured to interact with the proximity system of the other of the first and second electronic devices to determine proximity between the first and second electronic devices. The communication system of the first electronic device is configured to establish an association status communication with the communication system of the second electronic device after the proximity of the first and second electronic devices has been determined. Further, one of the first and second electronic devices is configured to notify an operator of an association status of the first and second electronic devices.

In accordance with another embodiment, a method for managing wireless devices in a wireless network includes determining a presence of one of a pair of electronic devices within a proximity zone of the other of the pair of electronic devices, determining an association status of the pair of electronic devices to each other after the presence of the one of the pair of electronic devices is determined to be within the proximity zone of the other electronic device, and notifying an operator of the association status of the pair of electronic devices. The pair of electronic devices each have a wireless communication system, where the wireless communication systems are configured to communicate in a communication zone having a larger area than an area of the proximity zone.

In accordance with yet another embodiment, a wireless system includes a proximity sensing system configured to wirelessly sense a proximity of a central hub device to a peripheral device within a proximity range of the proximity sensing system, a wireless communication system having a communication range greater than the proximity range, and a notification system configured to notify an operator of an association status of the central hub device and the peripheral device. The wireless communication system is configured to perform wireless communications between the central hub device and the peripheral device, and activate an association status communication between the central hub device and the peripheral device. The association status communication is activated after the proximity of the central hub device to the peripheral device has been sensed.

The invention has been described in terms of the preferred embodiment, and it is recognized that equivalents, alternatives, and modifications, aside from those expressly stated, are possible and within the scope of the appending claims.

What is claimed is:

1. A wireless system comprising:
a first electronic device having a wireless communication system and a proximity system;
a second electronic device having a wireless communication system and a proximity system, the wireless communication systems of the first and second electronic devices having a communication range therebetween greater than an interaction range between the proximity systems of the first and second electronic devices;
wherein the proximity system of one of the first and second electronic devices is configured to interact with the proximity system of the other of the first and second electronic devices to determine proximity between the first and second electronic devices;
wherein the communication system of the first electronic device is configured to establish an association status communication with the communication system of the second electronic device after the proximity of the first and second electronic devices has been determined; and
wherein one of the first and second electronic devices is configured to notify an operator of an association status of the first and second electronic devices.

2. The system of claim 1 wherein the association status communication comprises a packet of association information identifying electronic devices already associated with the first electronic device, the packet transmitted from the first electronic device to the second electronic device.

3. The system of claim 2 wherein the second electronic device is configured to determine an association status of the second electronic device with the first electronic device from the packet of association information.

4. The system of claim 3 wherein the second electronic device is configured to disassociate itself from the first electronic device if the second electronic device determines from the association status that the second electronic device is associated with the first electronic device.

5. The system of claim 3 wherein the second electronic device is configured to transmit an association information packet reply to the first electronic device, wherein the association information packet reply comprises an identifier unique to the second electronic device and an identified slot during which the second electronic device will communicate with the first electronic device.

6. The system of claim 3 wherein the second electronic device is configured to determine the association status during the interaction between the proximity systems of the first and second electronic devices.

7. The system of claim 3 wherein at least one of the first and the second electronic devices is configured to initiate an association timer, and wherein the second electronic device is configured to determine the association status before expiration of the association timer.

8. The system of claim 1 wherein the association status communication is established only after the proximity of the first and second electronic devices has been determined.

9. A method for managing wireless devices in a wireless network:
determining a presence of one of a pair of electronic devices within a proximity zone of the other of the pair of electronic devices, the pair of electronic devices each having a wireless communication system, wherein the wireless communication systems are configured to communicate in a communication zone having a larger area than an area of the proximity zone;
determining an association status of the pair of electronic devices to each other after the presence of the one of the pair of electronic devices is determined to be within the proximity zone of the other electronic device; and
notifying an operator of the association status of the pair of electronic devices.

10. The method of claim 9 wherein the pair of electronic devices each have a proximity sensing system, and wherein determining the presence of the one of the pair of electronic devices within the proximity zone of the other of the pair of electronic devices comprises determining interaction between the proximity sensing systems of the pair of electronic devices.

11. The method of claim 9 wherein the one of the pair of electronic devices is a body-worn peripheral device and the other of the pair of electronic devices is a central hub device.

12. The method of claim 11 wherein determining the association status comprises:
transmitting a network key from the central hub device to the peripheral device;
determining if an open communication slot exists from the network key; and
if the open communication slot exists:
assigning the peripheral device to the open communication slot;
transmitting a network key reply from the peripheral device to the central hub device, the network key reply identifying the peripheral device and the open communication slot assigned to the peripheral device; and
notifying the operator that the pair of electronic devices have been associated.

13. The method of claim 12 wherein determining the association status comprises notifying the operator that the pair of electronic devices are not associated because of a full network if no open communication slot exists.

14. The method of claim 11 wherein determining the association status comprises:
transmitting a network key from the central hub device to the peripheral device;
determining an agreement between the peripheral device and the central hub device that the peripheral device and the central hub device are associated; and
disassociate the peripheral device and the central hub device if the agreement has been determined.

15. The method of claim 9 wherein the step of determining the association status of the pair of electronic devices to each other comprises determining the association status of the pair of electronic devices to each only after the presence of the one of the pair of electronic devices is determined to be within the proximity zone of the other electronic device

16. A wireless system comprising:
a proximity sensing system configured to sense a proximity of a central hub device to a peripheral device within a proximity range of the proximity sensing system;
a wireless communication system having a communication range greater than the proximity range, wherein the wireless communication system is configured to:
perform wireless communications between the central hub device and the peripheral device; and
activate an association status communication between the central hub device and the peripheral device after the proximity of the central hub device to the peripheral device has been sensed; and
a notification system configured to notify an operator of an association status of the central hub device and the peripheral device.

17. The wireless system of claim 16 wherein the peripheral device is configured to determine association status while in the proximity of the central hub device.

18. The wireless system of claim 16 wherein the peripheral device is configured to determine association status during a predetermined time period after the proximity of the central hub device is sensed.

19. The wireless system of claim 16 wherein the proximity sensing system comprises one of a mechanical switch, a field strength detector, and a field strength temporal gradient detector.

20. The wireless system of claim 19 wherein the field strength detector or the field strength temporal gradient detector is configured to detect field strength that results from one of a magnetic source, a radio frequency source, an ultrasound source, a visible light source, and an infra red source.

21. The system of claim 16 wherein the central hub device is configured to identify the peripheral device via a timer correspondence between a peripheral device timer and a central hub timer.

22. The system of claim 16 wherein the notification system comprises one of an audio device, a visual device, and a tactile device for notifying the operator of the association status.

23. The system of claim 16 wherein the association status indicates one of association, disassociation, and unavailability of communication time periods.

24. The system of claim 16 wherein the central hub device is configured to transmit a current status communication to the peripheral device; and
wherein the peripheral device is configured to activate the notification system if the peripheral device is associated with the central hub device.

25. The system of claim 16 wherein the wireless communication system is configured to activate the association status communication only after the proximity of the central hub device to the peripheral device has been sensed.
